(19) United States
(12) Patent Application Publication
(10) Pub. No.: US 2014/0167507 A1
(43) Pub. Date: Jun. 19, 2014

(54) Methods of controlling externally controllable power supplies

(71) Applicant: Carl Lee Danner, Bakersfield, CA (US)

(72) Inventor: Carl Lee Danner, Bakersfield, CA (US)

(21) Appl. No.: 13/712,967

(22) Filed: Dec. 13, 2012

(51) Int. Cl. H02J 4/00

(52) U.S. Cl. CPC H02J 4/00
USPC 307/31

(57) ABSTRACT

In a first embodiment a powered device has a director that creates directions such as “increase power” or “decrease power”. The directions are sent to a voltage source controller in an externally controllable power supply. The voltage source controller creates control signals so as to comply with the directions. The signals control the level of voltage that a power source delivers to the powered device. In a second embodiment the same powered device has the same director and creates the same directions as in the first embodiment. The directions are sent to a current source controller in an externally controllable power supply. The current source controller creates control signals so as to comply with the directions. The signals control the level of current that a power source delivers to the powered device.

References Cited
U.S. Patent Documents

| | | |
|---|---|---|
| 7,844,370 | November 2010 | Pollack |
| RE41675 | May 2006 | Liu |
| 7,414,332 | August 2008 | Ohsuga |
| 7,411,371 | August 2008 | Hobbs |

### FIELD OF THE INVENTION

This invention relates to externally controllable power supplies.

### BACKGROUND OF THE INVENTION

Externally controllable power sources can be controlled by a signal that is created by a power needs processor located with a powered device. Locating the power needs processor with the powered device allows the power needs processor easy access to sensor information from the powered device. Specifications of the powered device can also be put into the power needs processor. This specifications information, sensor and other information permits the power needs processor to determine many things about the power requirements of the powered device. This allows the power needs processor to develop control signals that are sent to the externally controllable power source which then delivers power that is specific to the needs of the powered device.

There are currently two main types of externally controllable power sources based on control methods. One type of prior art externally controllable power source has no signal processing in the externally controllable source other than circuits associated with each internal source that allow the internal source to be controlled. The externally controllable source does not make decisions about power output. The control signal for each internal source is developed by a controller that is associated with the powered device. This control method requires that the controller must know something about the internal operation of the power source in order to control it.

Another prior art externally controllable power source uses a power request signal from an external power request generator. The power request specifies the value of a power parameter that the externally controllable source is to provide. The externally controllable power source is expected to provide power having the level of power requested at all times. Having a requested level of power at all times is important for some equipment. Requiring a specific level of power at all times results in more complex power request methods than are needed by some equipment such as batteries.

It is therefore an object of the present invention to provide an external control method that has does not require an external controller to know anything about the internal power source.

It is a further object of the present invention to provide a power control method that is less complex than using a power request.

### SUMMARY OF THE INVENTION

In accordance with these and other objects of the invention there are provided methods of controlling an externally controllable power source that do not need to know anything about the internal power sources that are to be controlled and do not require a level of a power parameter to be specified.

The new type externally controllable power source responds to power directions. The two most important directions are “increase power” and “decrease power”. Additional directions such as “hold present power level” or “increase rate of change of power” or “decrease rate of change of power” may be needed in some cases. The director does not need to develop different control signals for different power sources. Using directions is simpler than using a power request because directions do not specify a power level. It might seem that a source controller that responds to directions can be simple because there may only be two or three directions that are given, however a source controller that responds to directions needs to be more intelligent than a source controller responding to power requests because it must make decisions about power output based on less information. A source controller that is responding to an “increase power” direction has no way of knowing how much power the powered device needs. The source controller must be careful not to over-power the powered device. The source controller of the present invention may not be able to deliver as much power as the powered device needs in order to prevent damage to the powered device therefore the present invention may not be suitable for delivering power to some motors or other equipment that could be damaged by receiving too little power.

A first type of externally controllable power supply uses a source controller that only understands “increase power” or “decrease power”. A power source usually varies only one power parameter so as to increase or decrease power. The parameters that are normally varied are voltage, current, and resistance. Externally controllable power sources can respond to the same power directions regardless of whether voltage, current, or resistance of the source is being varied.

There are at least three embodiments for this first type controller, one each for voltage, current, and resistance. What changes is the parameter that is controlled in the source and the programming of the source controller. The “increase power”, “decrease power” signal stays the same in each embodiment.

In a first embodiment the externally controllable power source has an internal power source that varies source voltage. A director associated with a powered device sends a direction to a source controller. The source controller develops internal source control signals so as to vary voltage in accordance with the direction. Here is a more detailed functional description. A director uses sensor information and powered device specifications and perhaps an external control signal to decide if the powered device needs more or less power. The director sends an “increase power” or “decrease power” signal as appropriate. The internal power source should always be disconnected from the power output jack when the externally controlled power source is not supplying power. This is necessary for safety but it is also necessary to isolate the source from the powered device. The source controller will check to see if the voltage of the controllable source is the same as the voltage at the powered device when a powered device is first connected to the externally controllable power source power output jack. If the two voltages are not the same then the source controller will adjust the controllable source voltage to match the powered device voltage. The source controller will connect the source to the powered device when the two voltages are matched. If the source controller is receiving an “increase power” signal then the source controller will begin increasing source voltage while monitoring the signal from the director. The source controller has no way of knowing how much to increase power. The source controller will send a signal that it knows may increase the unloaded voltage at the controllable source by a small but known amount. The source controller may use this small voltage increase to develop knowledge about the powered device's specifications. The source controller may look at how much the voltage has increased at the powered device. If the voltage has increased very little compared to the known unloaded voltage then the source controller knows that it is probably safe to increase voltage at a faster rate. The manufacturer of the externally controllable power source will need to program the source controller to decide how rapidly to increase power since the director is only sending “increase power” or “decrease power” signals in this embodiment. The manufacturer of the externally controllable source will also need to decide how frequently the source controller will respond to a direction. This is necessary because it is quite likely that the director will keep the same direction on continuously until the director decides to change direction. The source controller will begin decreasing source voltage if it sees a “decrease power” signal. The source controller will continue increasing or decreasing voltage as directed by the director until current flow into the powered device is substantially lower than highest current flow. The controller may disconnect the source from the powered device when it sees this lower current flow.

A second embodiment is the same as the first except the externally controllable power source has an internal power source that varies source current. The operation of the source current controller is different than the operation of a source controller that is controlling voltage or resistance. Here is a functional description.

A director uses device specifications, sensor information about the powered device, and perhaps an external control signal to decide if the powered device needs more or less power. The director sends an “increase power” or “decrease power” signal as appropriate. If the source controller does not see any voltage at the power output jack then the internal power source or sources of the externally controllable source are always set to zero current. If the source controller is receiving an “increase power” signal then the source controller will check for a voltage from the powered device at the power output jack. If the controller sees powered device voltage then it will begin increasing source current while monitoring the signal from the director. When the source controller sees a “decrease power” signal it will begin decreasing source current. The source controller will continue increasing or decreasing current as directed by the director until current flow into the powered device reaches a level that low compared to highest current flow. At this time it may disconnect the source from the powered device. You may have noticed that the source controller did not attempt to match voltage at the source to that at the powered device. That is because voltage is not being controlled. The fact that voltage at the source need not be matched to the voltage at the powered device may make current sources easier to implement than voltage sources. There may be some arcing when the source is first connected to the powered device but arcing can be minimized if the internal resistance of the controllable source is high when it is first connected. The voltage of a current source must always be higher than that at the powered device. The voltage at the controllable source may stay the same or the voltage may increase as current is increased. If the voltage at the controllable source stays the same then the source controller is controlling the internal resistance of the source so as to control current. This is a variable resistance source. Since variable resistance and variable current sources are similar in operation variable resistance sources will not be discussed further.

There are other types of power directors such as those that can send other types of directions such as “hold present power level” or “increase rate of change of power” etc. These are not described in this document as they are obvious expansions on the basic idea of sending directions.

### BRIEF DESCRIPTION OF THE DRAWINGS

The foregoing and other objects and features of the present invention can be more readily understood with reference to the following description, taken in conjunction with accompanying drawings. Like reference numerals designate like electrical elements. Dotted lines represent status signal lines, power control signals, sensor information, or controllable source signals. Solid lines represent power conductors.

FIG. 1 shows an aspect of the present invention. A director receives information from sensors in a powered device or other external information. The director will use this information and information it has about specifications of the powered device to develop a direction signal. The direction signal is sent to a source voltage controller which uses the direction signal and information from voltmeters and an ammeter to develop a control signal. The source voltage controller will monitor voltmeters to compare the voltage at the source and the voltage at the powered device. If these voltages are significantly different then the source voltage controller normally open switch will remain open until the controller can match the source voltage to the powered device voltage. When the voltages are close to being the same the controller will close the switch if it is receiving an “increase power” direction from the director. The controller will then send a signal to the internal source telling the source to increase voltage. The controller will start out by providing a small voltage increase signal and then increasing voltage slowly. The slow increase rate is necessary until the controller can determine the power handling capabilities of the powered device. One way the controller can do this is to look at how much the voltage increases. If the voltage increases significantly then the controller will know that the powered device is has a high internal resistance. If this is the case then the controller will increase power slowly so as to not exceed the powered device voltage rating. The controller will then use the ammeter to check the status of power flowing from the source to the powered device. Power flow will stop and the controller will open the switch when the ammeter shows a low current flowing into the powered device relative to the highest current that was flowing to the powered device and the controller is receiving a “decrease power” signal from the director.

FIG. 2 shows another aspect of the present invention. A director receives information from sensors in a powered device. The director will use the sensor information and information it has about specifications of the powered device to develop a direction signal. The direction signal is sent to a source current controller. The source current controller uses source specifications, the direction signal from the director, and information from a voltmeter that monitors voltage at the powered device, and an ammeter between the controllable source and the powered device to develop a current control signal. A voltmeter at the source may not be needed since source voltage is not being controlled. The source current controller will monitor the voltmeter at the powered device and an ammeter to check the status of power flowing from the source to the powered device. When the current controller sees an “increase power” signal from the director it will begin providing minimum current. If the controller continues to see an “increase power” signal then the controller will continue increasing current until it sees a “decrease power” signal from the director. The rate of current increase will need to be slow enough that the director can react to decrease power before current flow becomes too high. The controller will continue decreasing power as long as it sees the “decrease power” signal. The current source controller may stop current flow when the controller is receiving a “decrease power” signal from the director and the controller sees a low current level relative to the highest current level that was flowing to the powered device.

### DETAILED DESCRIPTION OF THE INVENTION

It should be understood that although the invention is described with reference to providing power to a powered device, direct current electrical power may be supplied to an energy storage device such as a battery. It is contemplated that the principles of the invention may be employed to provide power to other types of equipment or to providing other types of power such as alternating current with multiple phases or hydro or gas pressure power. Use of the present invention with large mining equipment or other powered machinery may allow for more efficient control of power. Electrical power is used in this document because it is a common type of power.

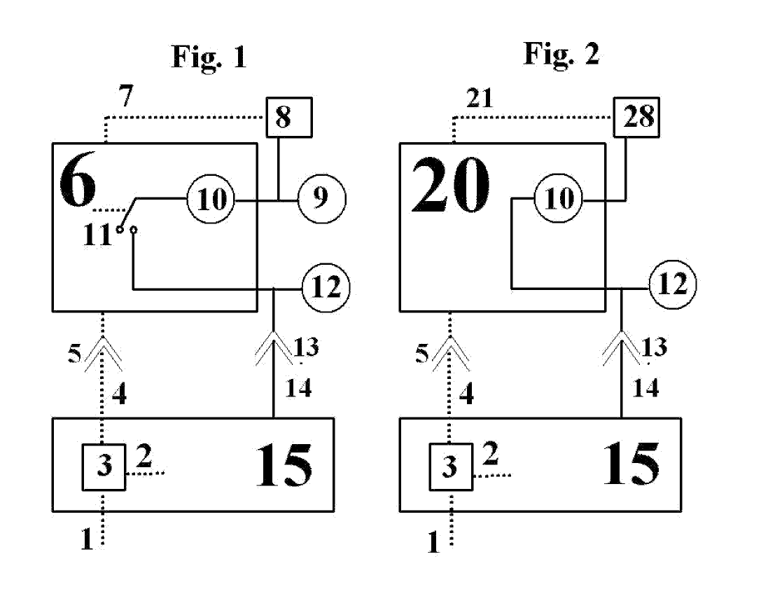

Referring now to FIG. 1 of the drawings, a block diagram shows a voltage source controller 6. Sensor information 2 is received from sensors located in powered device 15. These sensors may monitor temperature of device 15, voltage and current flow at 14 etc. External information is received at 1. External information could be information about the number of times a battery has been charged or a request to increase the speed of a motor etc. Director 3 contains specifications for powered device 15. Sensor or other information 2 and device 15 specifications are used by director 3 to create a direction signal 4. Direction signal 4 is delivered to voltage source controller 6 via plug/jack 5. A switch 11 which is open when power is not being delivered allows source controller 6 to monitor voltage of powered device 15 at voltmeter 12 via plug/jack 13. Source controller 6 compares powered device voltage 12 to internal source 8 voltage at voltmeter 9. If these two voltages are not the same then source controller 6 will develop voltage control signal 7 which will adjust the voltage output of voltage source 8 so that voltage at meter 9 matches voltage at meter 12. Voltage controller 6 will then close switch 11. Ammeter 10 should read zero since the two voltages are the same at this time. Voltage controller 6 does not know the amount of power that device 15 is capable of safely using. Director 3 is sending an “increase power” direction to voltage controller 6. No other signals are being sent to voltage controller 6 except device 15 voltage at voltmeter 12 previously mentioned. Device 6 will send signal 7 to source 8 so as to increase voltage at voltmeters 9 and 12. The amount of this first voltage increase will be determined by the manufacturer. Let's say that it is one percent of the voltage at meter 12. Current at ammeter 10 will increase as current flows from internal source 8 via ammeter 10, switch 11 and plug/jack 13 to powered device 15 so as to provide a power 14. The rate of change of voltage should be low enough that the director 3 has time to change direction 4 so as to prevent damage to powered device 15. Controller 6 will turn off source 8 when controller 6 sees a “decrease power” signal 4 from director 3 and current at ammeter 10 is at a low level compared to current flow as controller 6 was increasing voltage.

Referring now to FIG. 2 of the drawings, a block diagram shows the same powered device 15 as was shown in FIG. 1. Powered device 15 will now obtain power from a current source 28. Sensors 2 are located in powered device 15. These sensors may monitor voltage, temperature, current flow at 14 etc. Director 3 contains specifications for powered device 15. Sensor information 2 or other information 1 and powered device 15 specifications are used by director 3 to create a direction signal 4. Direction signal 4 is delivered to current source controller 20 via plug/jack 5. Current source 28 is off. Current controller 20 will send signal 21 to current source 28 if it sees a voltage at meter 12. Signal 21 will turn current source 28 on but only at a low current level when it first sees voltage at meter 12. The reason that current will be furnished at a low level is that current source controller 20 does not know the internal resistance of powered device 15. The voltage of current source 28 will probably be quite high since current source 28 is designed to be able to furnish current to many different types of powered devices. Some of these powered devices may operate at high voltage. Others may operate at lower voltage. For this reason current source controller 20 will furnish low current so as to not damage power device 15. It is expected that the powered device internal impedance will load down the high voltage to a safe level. Current source controller 20 does not yet know the amount of power that device 15 is capable of safely using. Current source controller 20 can calculate the internal resistance of device 15. Current source controller 20 can use the internal resistance of current source 28, current at meter 10 and voltage at meter 12 to calculate the internal resistance of device 15. This information can allow current source controller 20 to increase current at a rate that does not increase voltage at 12 too rapidly for director 3 to respond with a “decrease power” signal at 4. Director 3 is sending an “increase power” direction to current controller 20. No other signals are being sent to current controller 20 except device 15 voltage at voltmeter 12 previously mentioned. Current controller 20 will increase current at 14 while monitoring direction signal 4. Current at ammeter 10 will increase as current flows from internal source 28 via ammeter 10, and plug/jack 13 to powered device 15 so as to provide a power 14. Power 14 is theoretically the same power that was delivered to device 15 by the voltage source of FIG. 1. Controller 20 will turn off source 28 when controller 20 sees a “decrease power” signal 4 from director 3 and current at ammeter 10 is at a low level compared to current flow as controller 20 was increasing current.

Thus there have been shown and described power supply configurations that do not require a powered device to send control signals to internal power sources and that allow control of electric power used by powered devices or power storage devices such as batteries so as to deliver acceptable power. It is to be understood that the above-described embodiments of the invention are merely illustrative of many possible embodiments, which represent applications of the principle of the present invention. An internal source may be able to provide many types of electrical power such as hydraulic, compressed air, electric direct current, pulsed direct current, alternating current in various power configurations such as one phase, two phase, three phase, WYE, delta etc. It therefore should be obvious that these or other parameters may be delivered by an externally controllable power source without deviating from the spirit of the present invention. Numerous varied other arrangements can be readily devised in accordance with these principles by those skilled in the art without departing from the spirit and scope of the invention.

What is claimed is:

1. An externally controllable power source capable of modifying power output comprising:
means to deliver information about a first powered device to a first director;
means for said first director to develop first power control directions;
means to deliver information from said first director to a first power source controller, said delivery method delivering said first power control directions to said first power source controller;
means for said first power source controller to develop first power source control signals in response to said first power control directions;
means to deliver said first power source control signals to a first controllable power source;
means to create a power transfer connection between said first controllable power source and said first powered device so a first power can be delivered to said first powered device;
means to remove information delivery from said first director to said first power source controller;
means to remove said power transfer connection between said first controllable power source and said first powered device;
means to deliver information about a second powered device to a second director;
means for said second director to develop second power control directions;
means to deliver information from said second director to said first power source controller, said delivery method delivering said second power control directions to said first power source controller;
means for said first power source controller to develop second power source control signals in response to said second power control directions;
means to deliver said second power source control signals to said first controllable power source;
means to create a power transfer connection between said first controllable power source and said second powered device so said second power can be delivered to said second powered device;
means to remove information delivery from said second director to said first power source controller;
means to remove said power transfer connection between said first controllable power source and said second powered device.

2. The externally controllable power source capable of modifying power output of claim 1 wherein there are many more directors than the said first director and said second director, each of said many more directors being associated with a different said powered device.

3. The externally controllable power source capable of modifying power output of claim 1 wherein said power control directions are “increase power” and “decrease power”.

4. The externally controllable power source capable of modifying power output of claim 2 wherein said power control directions are “increase power” and “decrease power”.
